(19) United States
(12) Patent Application Publication
(10) Pub. No.: US 2016/0045862 A1
(43) Pub. Date: Feb. 18, 2016

(54) Dry Material Distribution Device for a Duct with Gas Flow

(71) Applicant: Breen Energy Solutions, L.L.C., Carnegie, PA (US)

(72) Inventors: Chetan Chothani, Pittsburgh, PA (US); Alan DePaoli, McDonald, PA (US); Christopher Petruccelli, Carnegie, PA (US)

(21) Appl. No.: 14/821,968

(22) Filed: Aug. 10, 2015

Related U.S. Application Data
(60) Provisional application No. 62/036,811, filed on Aug. 13, 2014.

(51) Int. Cl. B01D 53/79; B01D 53/50; B01D 53/10

(52) U.S. Cl. CPC B01D 53/79; B01D 53/10; B01D 53/508; B01D 2251/00; B01D 2253/00; B01D 2257/302

(57) ABSTRACT

A device for injecting dry material into a gas stream flowing through a duct or pipe has an injection tube having a first end configured for attachment to a dry sorbent supply, an upstream side and a downstream side. At least one opening on the downside side extends along the axial direction of the injection tube. A wake device is positioned adjacent the upstream side of the injection tube and creates turbulence in the gas stream as the gas stream passes around the wake device. An alternative embodiment utilizes an injector nozzle which combines a first stream containing dry material in air stream and a second stream which may be steam or water to form an output stream. A wake device is positioned adjacent the upstream side of the output of the injector nozzle. The wake device creates turbulence in the gas stream as the gas stream passes around the wake device.

### CROSS-REFERENCE TO RELATED APPLICATION

The present application claims priority to U.S. Provisional Application Ser. No. 62/036,811, which was filed on Aug. 13, 2014. The entirety of the Provisional Application is incorporated by reference herein.

### FIELD OF INVENTION

The invention relates to methods and devices for injecting dry material into a gas stream. More specifically the invention relates to injecting dry sorbent into flue gas.

### BACKGROUND

Control of pollution from fossil fueled combustion devices involves limiting and removing objectionable chemical species from the combustion generated flue-gases. Such removal is often accomplished by adsorbing the objectionable gaseous species unto solid particles which themselves can subsequently be removed, thus cleaning the flue-gas.

Dry sorbent injection (DSI) is such a technology whereby a chemical species, which has an affinity to react with the objectionable gaseous pollutant and further to form a solid particle, is injected into the flue-gas stream. An example of this technology is when colloidal slurry of lime or dry lime particles (the sorbent) are sprayed or injected into coal-fired flue-gases to adsorb sulfur oxide gases resulting from the combustion of coal. The absorbed sulfur species are removed from the flue-gas as solid particles of calcium sulfate which is the stable mineral known as gypsum.

The efficiency and therefore the practicality of sorbent injection pollution control processes depends upon how well the sorbent mixes and comes into contact with the gaseous pollutant. The surface area, particle size and such things as surface porosity of the sorbent all affect the probability that the gaseous pollutant will be absorbed by the sorbent particle; but first and foremost for efficient utilization, the sorbent particle must be distributed as uniformly as possible within the flue-gas flow.

Flue-gases are generated by the combustion of fossil fuels for the purpose of releasing heat which is to be used as heat input for such industrial processes as cement, steel and glass making, space heating or conversion of heat to electricity using electric utility boilers to generate steam. This invention applies to not only all such processes which generate flue-gases; but to any process in which it is desired to efficiently and uniformly mix a dry granular component with a gas stream.

The flue-gas is generally conveyed, at higher than ambient temperatures, through large ducts to various pollution control devices (back-end equipment) and thence to a chimney for exhaust to the atmosphere. A diagram of such a large duct is shown in FIG. 1, with gas flowing as indicated by the arrow. For the purpose of pollution control, or for many other chemical process purposes, it is desired to inject and distribute a dry material through an injector as also shown in FIG. 1. Conventionally the injector is a single pipe which may have an open end or a nozzle that injects dry material into the flue gas at a selected point.

In order to best distribute the dry sorbent within the flue-gas, numerous methods and devices have been of researched, developed, tested and patented. Often the sorbent is injected through use of a carrying media which may be liquid or gaseous and is meant to distribute or disperse the sorbent particles. However, practicality and costs dictate that there are only a finite number of injection points and that the resulting mixing is not completely uniform. Air is often used as the carrier fluid and the injection point creates a mixing plume which has a sorbent rich center surrounded by gradients of lesser concentrations of sorbent. The temperature of the carrier air is often different and much lower than the hot flue-gas and the viscosity differences of the hot versus cold gases cause them to remain segregated or poorly mixed. Thus many different devices have been developed and patented to improve the sorbent mixing and distribution while minimizing the number of injection points, the volume of carrier fluid and the associated injector equipment costs.

The use of a so called “delta wing” immersed within the hot flue-gas creates a turbulent wake behind the convex satellite shaped delta wing. Such a delta wing device as shown in FIG. 2a, is positioned upstream of the injection point of the dry material and creates wake eddies which greatly increase turbulence and mixing behind or downstream of itself.

When sorbent is injected on the downstream side of the delta wing, the turbulent wake of the wing creates turbulent eddies which essentially use the flue-gas itself to help distribute the sorbent. Since there is much more flue-gas than carrier gas and since the purpose is to mix into this larger volume of gas; this device leads to greatly improved distribution of the sorbent for any finite number of injection points and corresponding delta wings. However, each injection point must be at the center of each delta wing and this may require an array of multiple delta wings and associated injection piping.

Other turbulent wake devices shown in FIG. 2b, have been patented with simpler flat plate designs in which a flat wake generation plate is attached to the injection structure and piping. Such an adjustable spreading plate design of United Conveyor Corporation offers a simple device which causes minimal hot flue-gas operational pressure drop. All these turbulent wake devices greatly aid the mixing, uniformity and resulting efficiency of the dry sorbent injection process.

All of the dry sorbent injection devices known in the art have a region near the output of the dry sorbent where mixing of the sorbent and the flue gas occurs. However, the region is relatively small and localized at the output. Hence, the sorbent absorbs only a small portion of the target material that the sorbent has been injected to remove. One can improve the removal rate by providing one or more additional devices; but that adds costs to the system. Consequently, there is a need for a dry sorbent injection device that provides mixing of dry sorbent with more gas in the gas stream and thereby enables greater absorption and removal of the target material.

### SUMMARY OF THE INVENTION

We provide a dry material injection device which greatly improves upon the singular injection and centralized wake mixing of these previous mixing devices. We provide an injection tube having a first end configured for attachment to a dry material supply and an open end opposite the first end. The injection tube has an upstream side and a downstream side and at least one opening on the downside side. The opening or openings extend along the axial direction of the injection tube. A wake device is positioned adjacent the upstream side of the injection tube and creates turbulence in the gas stream as the gas stream passes around the wake device.

Our device creates a wake where the dry material is injected that is continuously extended in the axial direction of the injection tube for an arbitrary but carefully designed distance and the dry material is continuously fed or injected into this extended wake zone. We prefer to provide a singular centralized injection zone that extends axially along the injection tube. Hence we increase the region where mixing of the dry sorbent and flue gas occurs from a small localized region near a point source to an arbitrarily longer two dimensional injection zone. And likewise we prefer to use a two dimensionally distributed wake device. The dry material may be injected through a slot or series of slots cut axially in the injection tube or by use of a column or plume of a second carrier fluid such as steam or water or a combination of such.

An alternative embodiment utilizes an injector nozzle in place of the injection tube. The injector nozzle combines a first stream containing dry material in an air stream and a second stream which may be steam or water to form an output stream. A wake device is positioned adjacent the upstream side of the output of the injector nozzle. The wake device creates turbulence in the gas stream as the gas stream passes around the wake device.

Other objects and advantages will become apparent form a description of certain present preferred embodiments thereof which are shown in the drawings.

### BRIEF DESCRIPTION OF THE DRAWINGS

FIG. 1 is a diagram of a duct through which gas is flowing and into which a dry sorbent is being injected according to one method which is known in the art.

FIG. 2a is a diagram of a duct through which gas is flowing and into which a dry sorbent is being injected according to another known method that uses a delta wing.

FIG. 2b is a diagram of a duct through which gas is flowing and into which a dry sorbent is being injected according to yet another known method which uses a simple plate.

FIG. 3 is a diagram similar to FIGS. 1, 2a and 2b which shows dry sorbent being injected into flue gas using a first present embodiment of our injection device.

FIG. 4a is a photograph of the injection plume created when using a single point injector.

FIG. 4b is a photograph of the injection plume created when using our injection device.

FIG. 5 is a rear top view of a present preferred embodiment of our injection device.

FIG. 6 is a right side view of the embodiment shown in FIG. 5.

FIG. 7 is an end view of the embodiment shown in FIGS. 5 and 6.

FIG. 8 is a perspective view of a second present preferred embodiment of our injection device.

FIG. 9 is a diagram of third present preferred embodiment of our injection device attached to a pipe or duct.

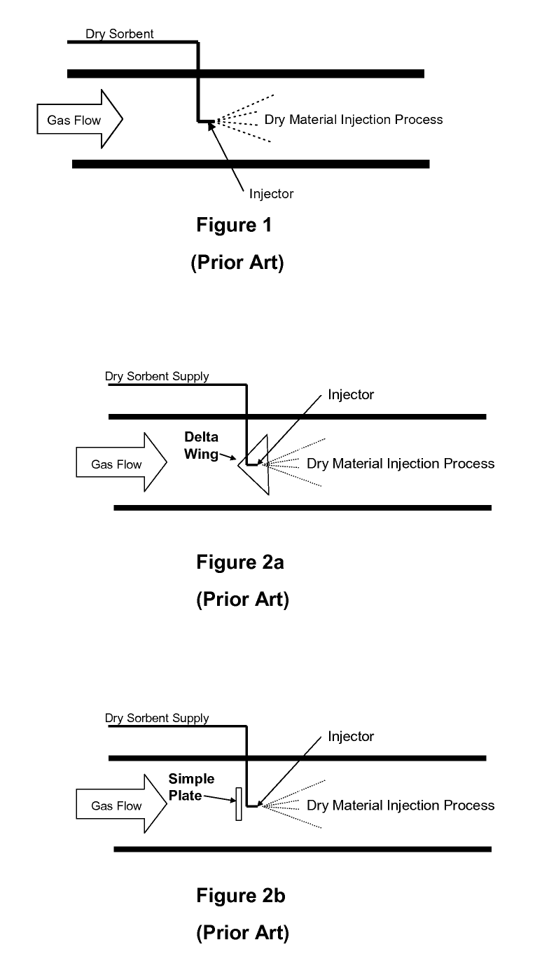

### DESCRIPTION OF THE PREFERRED EMBODIMENTS

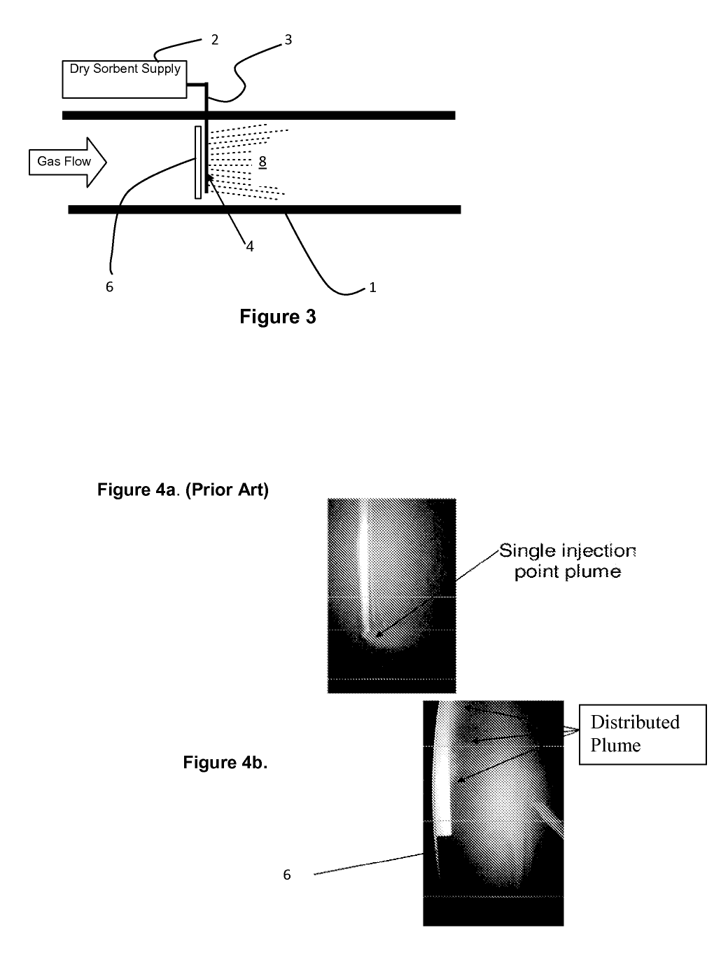

Our device builds upon the use of wake mixing, but rather than a singular point of injection into the wake; however formed, we extend the wake device in the axial direction of the injection tube so that the wake device creates a longitudinal turbulence zone of any desired length. In the embodiment shown in FIG. 3 gas is flowing through a duct or pipe 1 in the direction indicated by the arrow labeled “Gas Flow”. Dry sorbent from supply 2 is injected through supply conduit 3 into the gas flow through injection tube 4. The injection tube 4 is a pipe that has a slot or a series of openings along its length such that the dry sorbent is injected along a selected portion of the injection tube to inject a spray 8 of dry material into the duct or pipe through which the gas is flowing. A wake device 6 is provided upstream of the injection tube 4. For purpose of discussion the wake device 6 may be a flat plate as shown in FIG. 3, but any other shape wake device that creates a wake adjacent the injection tube 4 would serve the same purpose. The wake device 6 creates an extended turbulent wake zone in the gas that is flowing past the wake device.

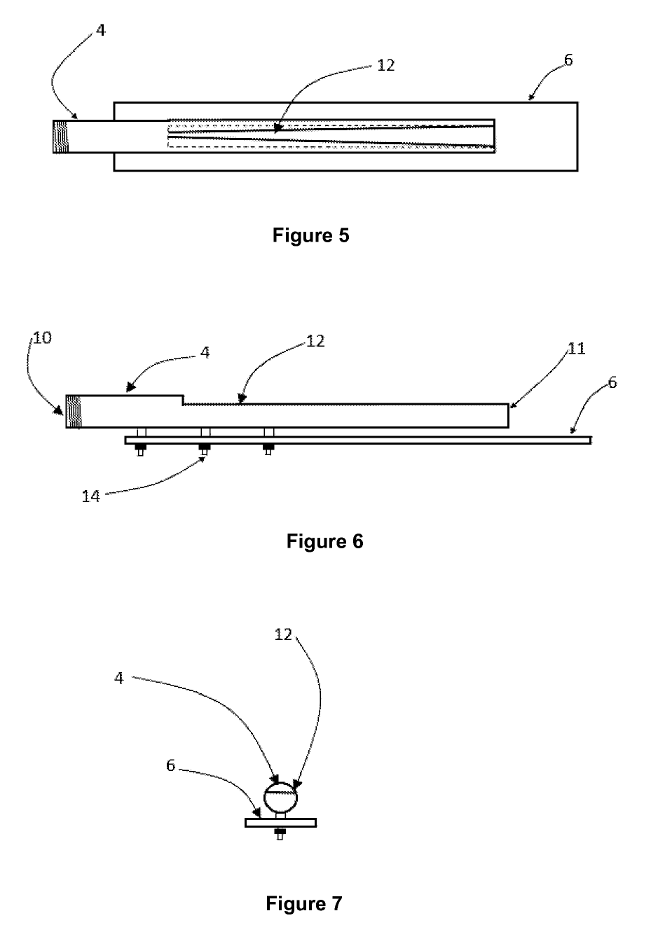

In the embodiment shown in FIGS. 5, 6 and 7 the wake device 6 is a flat plate the extends beyond the open end 11 of the injection tube 4. The extended turbulent wake zone created by our extended flat plate creates an associated extended low pressure zone into which the dry sorbent is continuously injected. We have found that this low pressure zone helps to draw the dry material from the continuous injection tube along its axial direction.

The continuous sorbent injection and the wake resulting from the extended flat plate 6 interact to fill a vacuum created by the wake with uniformly mixed sorbent. The wake and the flow of dry sorbent through the injection tube subsequently distributes the dry sorbent into a greatly extended two dimensional mixing zone with the rest of the gas.

The continuous injection may be accomplished by a series of injection points along the injection tube or by various slots in the tube along its axial direction. However we have found that it is advantageous to have a single “Vee” cut slot 12 of increasing width in the axial direction along the injection tube 4 as shown in FIGS. 5 and 6. The Vee slot may be cut along a line that coincides with the downstream direction of the gas stream or elsewhere on the downstream side of the injection tube 4. This downstream side covers half of the circumference of the injection tube that faces away from the source of the gas that is flowing through the duct or pipe in which the injection tube is placed. The Vee slot is designed to match the decreasing velocity within the constant projected diameter (Flow Area) of the injection tube 4 as the dry sorbent flows out of the injection tube 4 so that the sorbent flow, injected into the duct, remains relatively constant along the axis of the injection tube.

Use of a “Vee” slot in the axial extension of the injection tube helps prevent dry sorbent bridging and keeps clear with the higher velocity of injection pressure at the beginning of the Vee; while allowing the vacuum of the wake to help draw the dry material at the lower static flow pressure as the Vee opens and the flow velocity decreases in the axial direction. Thus the Vee slot may be designed to have at least the same open area as the cross-section of the tube, but the optimum opening may be determined through trial-and-error experiments, computer modeling or a combination of testing aided by computer fluid-dynamics modeling.

In practice we have found that optimum slots or Vees can be matched with the dimensions of the wake device so that the continuous injection can be extended to lengths of over 4 feet. Photographs were taken during testing and optimization of our device and comparisons of different injection plumes are shown in FIGS. 4a and 4b. For comparison a single point injection plume is shown in FIG. 4a, while the extended plume of a 28 inch slot is shown in FIG. 4b. This experimental demonstration shows that an increased plume zone of more than ten times the single point injection plume is achieved with the same dry material flow and injection tube size.

The embodiment of our device shown in FIGS. 5, 6 and 7 takes advantage of the optimum matching of the wake device with the extended axial injection. This also includes designing the combination to not foul or clog during long term trouble-free operation. The embodiment shown in FIGS. 5, 6 and 7 has several features which not only increase dry material distribution in a duct with gas flow, but also prevent clogging for more trouble-free injection.

The device shown in FIGS. 5, 6 and 7 has an injection tube 4 having a threaded end 10 and an open end 11. The threaded end is attached to a pipe 3 which supplies dry sorbent from the dry sorbent supply 2 as shown in FIG. 3. There is a Vee slot 12 in the injection tube 4. Alternatively the slot may be straight as indicated by the broken line in FIG. 5. A wake plate 6 is attached to the upstream side of the injection tube 14. The wake plate 6 is sized to match the optimum turbulent zone and may extend beyond the end of the injection tube 4. Being attached to the injection tube 4, the wake plate 6 creates vibrations or shaking which helps to prevent clogging of the dry material in the injection tube. As shown in this FIG. 6, two or more nuts and bolts 14 are used to hold the top section of the wake plate 6 rigid to the injection tube 4, the remaining 25% to 90% of the plate length is left free to hit against and shake the injection tube, thus helping to prevent clogging. Although we prefer to attach the wake plate to the injection tube one could attach the wake plate to a different structure if that attachment positions the wake plate adjacent the upstream side of the injection tube.

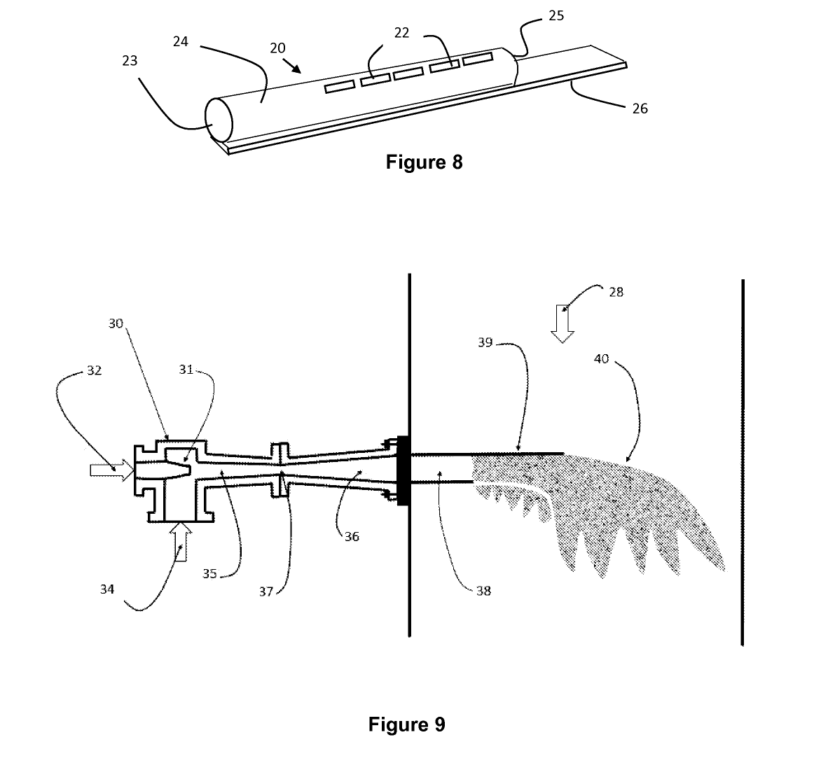

A second present preferred embodiment shown in FIG. 8 is similar to the embodiment shown in FIGS. 5, 6 and 7. In this device 20 there is an injection tube 24 that has a series of slots 22 along the axial direction of the injection tube 24. The injection tube has one end 23 that is attached to a dry material supply pipe (not shown) and a second end 25 opposite the first end. A wake device 26 is attached to the upstream side of the injection tube.

This distributed injection provided by the devices shown in FIGS. 5 through 8 can be achieved by use of a steam or water injection nozzle which combines a second carrier fluid such as steam or water with the dry sorbent carried on stream of air. This nozzle is used in place of the slotted injection tube. Such an embodiment 30 is shown in FIG. 9. An injection nozzle 31 combines the second carrier fluid which may be steam, water or other motive fluid indicated by arrow 32 with dry sorbent material in an air stream indicated by arrow 34. The second carrier stream may be traveling at a velocity that is the same as the velocity of the air stream carrying the dry sorbent or at a velocity that is up to 1000 time greater than that velocity. The two streams are mixed at the convergent section 35 and pass into the divergent section 36 after passing through a diffuser throat 37. Then the combined streams are injected into the duct or pipe 1 through outlet 38. As in the previous embodiments a wake device, specifically wake plate 39, is attached to the outlet pipe 38. The gas flowing through the duct or pipe indicated by arrow 28 strikes the wake device 39 creating turbulence. That turbulence creates an injection plume 40 of dry sorbent with the carrier fluids, typically air and steam. In this embodiment the second carrier fluid sucks the dry sorbent into a converging nozzle and then going through an outlet diffuser forms a high velocity plume which serves to distribute the dry sorbent in the same way as the slotted injection tube. The motive fluid in the second carrier can be either steam or water or any combination thereof.

The motive fluid may also contain various additives which may improve the operation of specific back-end pollution control equipment. For example, trace amounts of ammonia are known to lower ash resistivity and improve the operation of electrostatic precipitators.

The removal of many pollutants may be enhanced by the presence of increased water or gaseous steam. For example in the removal of acid gases, the moisture content of the flue gas helps to convert the molecule into its acid form; such as when sulfur trioxide is converted to gaseous sulfuric acid the acid more readily adsorbs to the sorbent surface. Thus the motive fluid itself improves the effectiveness of the dry sorbent by adding moisture to the sorbent surface and by enhancing the conversion of sulfate to sulfuric acid in the gas phase.

Use of a wake device will also increase the cross-duct distribution of the dry sorbent by inducing the same wake vacuum downstream of the steam ejector penetrating jet. The wake plate as shown in FIG. 9, has the effect of producing a vacuum wake downstream of the injection jet and thus can increase the cross-duct distribution of the plume and the dry sorbent.

Even though we have described our injection device being used to inject dry sorbent into flue gas, the device is not so limited and may be used to inject any dry material into any gas stream that is flowing through a duct or pipe.

Although we have described various present preferred embodiments of our dry sorbent injection device our invention is not limited thereto but may be variously embodied within the scope of the following claims.

We claim:

1. An injection device for injecting dry material into a gas stream that is flowing through a pipe or duct comprising:
an injection tube having a first end configured for attachment to a dry sorbent supply and a second end opposite the first end, the injection tube having a selected length and an axial direction that extends along the axial direction of the injection tube, the injection tube having a upstream side and a downstream side and at least one opening extending in the axial direction on the downstream side; and
a wake device positioned adjacent the upstream side of the injection tube, the wake device sized and configured to create turbulence in the gas stream as the gas stream passes around the wake device.

2. The injection device of claim 1 wherein the wake device is a flat plate.

3. The injection device of claim 2 wherein the flat plate has a first end and a second end opposite the first end, the first end of the flat plate being attached to the injection tube.

4. The injection device of claim 3 wherein the flat plate is attached to the injection tube in a manner so that the flat plate can vibrate.

5. The injection device of claim 3 wherein the flat plate is attached to the injection tube in a manner so that the second end of the flat plate can move relative to the second end of the injection tube.

6. The injection device of claim 3 wherein the second end of the wake device extends beyond the second end of the injection tube.

7. The injection device of claim 1 wherein the at least one opening in the injection tube is a single slot.

8. The injection device of claim 7 wherein the single slot has a Vee shape.

9. The injection device of claim 1 wherein the at least one opening in the injection tube is a plurality of slots.

10. The injection device of claim 1 wherein the dry material is a sorbent.

11. An injection device for injecting dry material into a gas stream that is flowing through a pipe or duct comprising:
an injector nozzle having a first input end configured for attachment to a dry material supply which supplies a first stream containing dry material in an air stream and a second input configured to receive a second stream, the first input and the second input connected to a convergent section where the first stream and the second stream are mixed and an output which is connected to the convergent section, the output having a upstream side and a downstream side; and
a wake device positioned adjacent the upstream side of the output of the injector nozzle, the wake device sized and configured to create turbulence in the gas stream as the gas stream passes around the wake device.

12. The injector device of claim 11 wherein the injector nozzle also comprises a divergent section connected between the convergent section and the output of the injector nozzle.

13. The injection device of claim 11 wherein the wake device is a flat plate.

14. The injection device of claim 11 wherein the dry material is a sorbent.

15. The injection device of claim 11 wherein the second stream contains steam or water.

16. The injection device of claim 11 wherein the second stream contains at least one additive that improves the operation of selected back-end pollution control equipment.

17. The injection device of claim 16 wherein the at least one additive is ammonia.

18. A method for injecting dry material into a gas stream that is flowing through a pipe or duct comprising:
providing an injector nozzle having a first input end configured for attachment to a dry material supply which supplies a first stream containing dry material in an air stream and a second input configured to receive a second stream, the first input and the second input connected to a convergent section where the first stream and the second stream are mixed, and an output which is connected to the convergent section, the output having a upstream side and a downstream side; and a wake device positioned adjacent the upstream side of the output of the injector nozzle, the wake device sized and configured to create turbulence in the gas stream as the gas stream passes around the wake device;
inputting the first stream containing dry material in an air stream into the injector nozzle through the first input at a first velocity;
inputting the second stream containing steam or water into the injector nozzle through the second input at a second velocity;
mixing the first stream with the second stream in the convergent section of the injector nozzle to form an output stream; and
outputting the output stream into a gas stream flowing through a duct or pipe.

19. The method of claim 18 wherein the second velocity is from 1 to one thousand times the first velocity.

20. The method of claim 18 wherein second stream contains at least one additive that improves the operation of selected back-end pollution control equipment.

21. The method of claim 20 wherein the at least one additive is ammonia.
